(19) United States
(12) Patent Application Publication
(10) Pub. No.: US 2024/0144118 A1
(43) Pub. Date: May 2, 2024

(54) SYSTEM FOR DECENTRALIZED AUTONOMOUS ORGANIZATION VETTED SELF-SOVEREIGN & NON FUNGIBLE TOKEN BASED SERVICE PROVIDER PLATFORM

(71) Applicant: Chandrasekhar Gundlapalli, Irving, TX (US)

(72) Inventor: Chandrasekhar Gundlapalli, Irving, TX (US)

(73) Assignee: ECHELON EMERGING TECH GROUP LLC, Irving, TX (US)

(21) Appl. No.: 17/975,776

(22) Filed: Oct. 28, 2022

(51) Int. Cl. G06Q 10/06; G06Q 10/10

(52) U.S. Cl. CPC G06Q 10/063112; G06Q 10/1053; G06Q 2220/00

(57) ABSTRACT

A computer-implemented system for real-time credible vetting of talents or candidates using blockchain is disclosed. The system comprises a computing device having a processor and a memory in communication with the processor, one or more databases in communication with the computing device via a network to store a plurality of candidate's information, and a user device associated with a user in communication with the computing device via the network configured to access one or more services provided by the system. The system enables the candidates to submit one or more candidate credentials on a user device. The candidate credentials are validated by a credible group of community members and are stored in the blockchain. The system matches the recruiters and candidates based on an assigned task and the candidate's expertise using artificial intelligence (AI) talent matching. Further, the system provides dynamic ratings or scores for candidates along with feedback.

### TECHNICAL FIELD

The present invention generally relates to talent and technology service providers platform. More specifically, the present invention relates to a system for Decentralized Autonomous Organization (DAO) vetted self-sovereign verifiable credentialed & Non-Fungible Token (NFT) based talent and technology service providers platform to find reliable candidates much faster.

### BACKGROUND

Talent and technology service provider platforms connect employees with greater career opportunities. This platform matches employees with career advancement opportunities based on each individual's existing skills and future goals. Further, the platform helps recruits find the best talent effectively. The platform is designed to support and automate human resource responsibilities in an organization.

Traditional talent and technology service provider platforms continue to offer recruiting and onboarding capabilities using various HR tools. Some platforms have references and recommendations featured that give users some feedback on the talent and the employers, however, this is static, not real-time, and biased.

Also, current platforms in the market do not show the complete picture of any proven talent. They only summarize candidates' past work, and some historical reviews of reputation and thus present a major challenge for any company looking to staff their next project. These platforms lack hiring process transparency as candidate credentials are stored in traditional systems which are not immutable and could be subjected to fraud. They also lack authentic 360-degree referrals and reviews by established community members that would lend them more credibility. As a result, in today's world, any proven candidates with top real performance reviews and achievements are not visible outside their current organizations. Traditional, manual verification of credibility of credentials and skills takes months slowing down the recruitment process immensely.

Further, the current platform lacks to provide a consolidated list of credible or vetted talent & niche tech vendors. It takes a very long cycle for the technology service providers to find credible talents and talents to find organizations looking for digitally savvy talent. The present talent job market does not use any community vouching or vetting based on their experience to validate candidates. Further, the platform lacks local community stamps or credentials and Web2 to Web3 identities that bridge with the real utility or business.

In light of the above-mentioned drawbacks, there is a need for a system that is a decentralized autonomous organization (DAO) vetted self-sovereign verifiable credentialed & Non-Fungible Token (NFT) based talent and technology service provider platform to find reliable candidates much faster. Also, there is a need for a system that stored candidates' traits as immutable records. And also, there is a need for a system that has greater transparency. Further, there is a need for a system that uses Web3 technologies to provide a real-time creditable vetting of talents using blockchain effectively and based on their actual capabilities and reputation.

### SUMMARY

The present invention generally discloses a talent and technology service providers platform. Also, the present invention discloses a system for Decentralized Autonomous Organization (DAO) self-sovereign verifiable credentialed & Non-Fungible Token (NFT) based talent and technology service providers platform to find reliable candidates much faster.

According to the present invention, the system is executed in a network environment for real-time credible vetting of users or candidates or talents using blockchain. The system runs in a computer-implemented network environment configured to provide a platform (i.e., Echelon) for candidates or talents to look for jobs and technology service providers to look for talent candidates. The technology service providers may include, but not limited to, recruiters, headhunters, and hiring managers. In one embodiment, the system is decentralization (DAO) vetted self-sovereign verifiable credentialed & Non-Fungible Token (NFT) based talent and technology service provider platform.

In one embodiment, the system uses Web3 technologies to find candidates with greater credibility in the talent pool. The Web3 technology is the next generation internet. In one embodiment, the Web3 technologies include decentralization, blockchain technologies, and token-based economics. In one embodiment, the system finds reliable candidates much faster and provides greater transparency. The system is built-on emerging technologies such as self-sovereign identity (SSI), AWS cloud and Web3, blockchain, decentralization, and artificial intelligence (AI) for profile matching.

In one embodiment, the system provides vetting of candidates by technical skills and soft skills. In one embodiment, the soft skills may include communication, leadership, teamwork, overall attitude, and ability to adapt by using a team of experts who are part of the recruitment community. In one embodiment, the system includes a unique four pillar talent accreditation process that allows community champions to review and authenticate the talent on or platform across one or more criteria. The criteria may include, but not limited to, domain knowledge, technical skills, soft or leadership skills, and local community endorsements. Further, the system is built using robust modern technology tools and methodologies that gives the edge in trust, reliability, security, and performance.

In one embodiment, the network environment comprises one or more user devices. The user device has an interactive user interface (UI). Each user device is associated with a user. In one embodiment, the user may be, but not limited to, candidate, talents, SMEs or any other resource looking for job. In one embodiment, the user device is installed with a digital platform (i.e., Echelon). In one embodiment, the digital platform may be an application software or mobile application or web-based application or software application, or desktop application. The system further comprises a communication network and a resource recruitment system. In one embodiment, the user device is enabled to access the resource recruitment system via the network. In one embodiment, the user device enables the user to access one or more services provided by the system. In one embodiment, the user device is at least any one of a smartphone, a mobile phone, a tablet, a laptop, a desktop, and/or other suitable hand-held electronic communication devices. In one embodiment, the user device comprises a storage medium in communication with the network to access the resource recruitment system. In an embodiment, the network could be Wi-Fi, WiMAX, wireless local area network (WLAN), satellite networks, cellular networks, private networks, and the like.

In one embodiment, the resource recruitment system comprises a computing device and one or more databases in communication with the computing device. In one embodiment, the computing device is a server. In one embodiment, the computing device could be a cloud server. In one embodiment, the server could be operated as a single computer. In some embodiments, the computer could be a touchscreen and/or non-touchscreen and adopted to run on any type of OS, such as iOS™, Windows™, Android™, Unix™, Linux™, and/or others. In one embodiment, the plurality of computers is in communication with each other, via networks. Such communication is established via any one of application software, a mobile application, a browser, an OS, and/or any combination thereof.

In one embodiment, the one or more databases are in communication with the computing device via the network. In one embodiment, the databases are accessible by the computing device. In another embodiment, the databases are integrated into the computing device or separate from it. In some embodiments, the databases reside in a connected server or a cloud computing service. Regardless of location, the databases comprise a memory to store and organize certain data for use by the computing device. In one embodiment, the database is configured to store a plurality of candidate information.

In one embodiment, the computing device comprises at least one processor and a non-transitory memory unit or computer-readable medium or memory unit coupled to the processor. The memory unit stores a set of instructions executable by the processor configured to find the candidate profiles that matches to the assigned task and candidate expertise. In one embodiment, the matching of candidates is done using artificial intelligence (AI) guided adaptive talent matching. The memory unit could be RAM, ROM (including EPROM, EEPROM, PROM).

In one embodiment, the computing device is configured to enable candidates to sign-up with a Web2 identity or Web3 identity; enable candidates to self-attest to skills and personal profiles; assign task or gig by executive recruiters or corporate users; match executive recruiters or corporate users and candidates based on task profile and candidate expertise; provide dynamic rating for candidates and small and medium size enterprises (SMEs).

In one embodiment, the system utilizes an AI-guided adaptive talent matching. The AI-guided adaptive talent matching comprises an adaptive recommendation engine and a best-fit talent matches. The adaptive recommendation engine process information such as talent credentials (supply—i.e., what the candidates say they are), endorsements (i.e., what the experts think they are), task requirements (demand—i.e., what the companies are looking for), performance reviews (i.e., what the candidates turned out to be), and recruitment (i.e., candidates evaluation and selection). The adaptive recommendation engine provides the processed information to the best-fit talent matches. The adaptive recommendation engine process all the information to recruit candidates fulfillment i.e., candidates onboard using best-fit talent matches.

In one embodiment, the system comprising talent candidates is connected to recruiters using an AI matchmaking system that leverages dynamic rating and SSI (Self Sovereign ID) skill credentials. In one embodiment, SSI is an approach to digital identity for the user. The SSI is Web3 integration with trust over IP framework. The SSI identities are obtained by the users in a blockchain network using following steps. At one step, the talent onboarding candidate submits profiles. At another step, the system performs community vetting or referring of talent based on past project experience. At another step, the talent credentials or self-sovereign identities are stored on an echelon platform or the user's identity wallet securely. At another step, the organizations or recruiters look for talents or best-fit for the job. The organization includes a recruiter, headhunter, and a small business talent acquisition. At another step, the proof material required to facilitate the validation of the self-sovereign skill credential is stored on a trust registry facilitated by a smart contract hosted on a blockchain network. This validation includes proof of origin and proof of non-revocation. Candidates can further choose to mint NFTs based on their skill credentials on the platform.

In one embodiment, the system further comprises one or more decentralized autonomous organization (DAO) community comprising one or more DAO members. The talent onboarding is performed using resource skillsets or technology service provider's comprising hard skills and soft skills. The resource skills are vetted by the DAO community. Each resource skills are vetted by related vetting scores based on vetting questionnaires and past partnership working experience. The vetting scores are provided with credentials (i.e., encryption). The encryption of the credentials is done using username and password and optionally, some sort of multi factor authentication. To further guarantee privacy while still maintaining universal verifiability, there is no personally identifiable information stored on the blockchain as part of the skill credential. The only data stored on the blockchain is the material required to validate the verifiable self-sovereign credential.

The above summary contains simplifications, generalizations, and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 shows a computer-implemented system executed in a network environment configured to perform real-time credible vetting of talents using blockchain, according to one embodiment of the present invention.

FIG. 2 shows a schematic representation of system architecture, according to one embodiment of the present invention.

FIG. 3 shows an AI guided adaptive talent matching, according to one embodiment of the present invention.

FIG. 4 shows an estimated talent worth algorithm, according to one embodiment of the present invention.

FIG. 5 shows a self-sovereign identities (SSI) and blockchain decentralization, according to one embodiment of the present invention.

FIG. 6 shows a system for SSI credential-based talent and technology vetting with DAO capabilities, according to one embodiment of the present invention.

FIG. 7 shows a DAO vetted self-sovereign verifiable credentialed and Non-Fungible Token (NFT) based talent and technology service provider system onboarding via DAO community, according to one embodiment of the present invention.

FIGS. 8-9 show screenshots illustrating different teams with diverse capabilities that work in collaboration to achieve the needs of the client DAO, according to one embodiment of the present invention.

FIG. 10 shows a flowchart demonstrating pre-vetted candidates & PODs, and community vetting, according to one embodiment of the present invention.

FIG. 11 shows Qualitative & Quantitative accountability at all layers and Echelon Token, according to one embodiment of the present invention.

FIG. 12 shows 4 pillar accreditation, according to one embodiment of the present invention.

FIG. 13 shows a screenshot illustrating a digital skills wallet of a candidate, according to one embodiment of the present invention.

FIGS. 14-15 show screenshots illustrating details of digital skills wallet of a selected candidate, according to one embodiment of the present invention.

FIG. 16 shows a screenshot illustrating candidate privacy, according to one embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

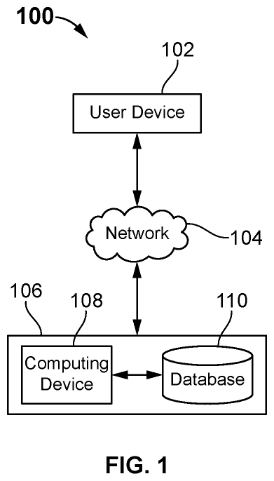

Referring to FIG. 1, a computer-implemented system executed in a network environment 100 for real-time credible vetting of talents using blockchain, according to one embodiment of the present invention. The system is a world's first non-fungible token (NFT)/blockchain credential-based talent & technology factory platform. In one embodiment, the system is a Decentralized Autonomous Organization (DAO) vetted self-sovereign verifiable credentialed & Non-Fungible Token (NFT) based talent and technology service provider platform. The DAO connects proven talent and technology service providers with organizations struggling to find vetted (soft and hard skills) talent instantly. Vetting is done by a DAO community with minimum of about 10-25 years of subject matter experts (industry vertical, emerging technology, and talent experts). The system majorly aims to help to close the gap between big talent and technology. The system brings proven workforce and niche technology providers to the organizations to accelerate digital transformation. Further, the system gets the worldwide talent ready for Gig economy with quantitative capacity models or resource availability forecast. Also, the system is a global platform with local community champions in each city.

In one embodiment, the system runs in a computer-implemented environment 100 configured to provide a platform (i.e., Echelon) for users or talents or candidates to look for jobs and technology service providers or organizations to look for talent candidates. The technology service providers may include, but not limited to, recruiters, headhunters, and hiring managers. In one embodiment, the system is decentralization (DAO) vetted self-sovereign verifiable credentialed & Non-Fungible Token (NFT) based talent and technology service provider platform. In one embodiment, the system uses Web3 technologies to find candidates with greater credibility in the talent pool. The Web3 technology is the next generation internet. In one embodiment, the Web3 technologies may include, but not limited to, decentralization, blockchain technologies, and token-based economics. In one embodiment, the system finds reliable candidates much faster and provides greater transparency. The system is built-on emerging technologies such as self-sovereign identity (SSI), AWS cloud and Web3, blockchain, decentralization, and artificial intelligence (AI) for profile matching.

In one embodiment, the system provides vetting of candidates by technical skills and soft skills. In one embodiment, the soft skills may include communication, leadership, teamwork, overall attitude, and ability to adapt by using a team of experts who are part of the recruitment community. Further, the system is built using robust modern technology tools and methodologies that gives the edge in trust, reliability, security, and performance.

In one embodiment, the network environment 100 comprises one or more user devices 102. The user device 102 has an interactive user interface. Each user device 102 is associated with a user. In one embodiment, the user may be, but not limited to, candidate, talents, SMEs or any other resource looking for job. In one embodiment, the user device 102 is installed with a digital platform (i.e., Echelon). In one embodiment, the digital platform may be an application software or mobile application or web-based application or software application, or desktop application. The system further comprises a communication network 104 and a resource recruitment system 106. In one embodiment, the user device 102 is enabled to access the resource recruitment system 106 via the network 104. In one embodiment, the user device 102 enables the user to access one or more services provided by the system. In one embodiment, the user device 102 is at least any one of a smartphone, a mobile phone, a tablet, a laptop, a desktop, and/or other suitable hand-held electronic communication devices. In one embodiment, the user device 102 comprises a storage medium in communication with the network 104 to access the resource recruitment system 106. In an embodiment, the network 104 could be Wi-Fi, WiMAX, wireless local area network (WLAN), satellite networks, cellular networks, private networks, and the like.

In one embodiment, the resource recruitment system 106 comprises a computing device 108 and one or more databases 110 in communication with the computing device 108. In one embodiment, the computing device 108 is a server. In one embodiment, the computing device 108 could be a cloud server. In one embodiment, the server could be operated as a single computer. In some embodiments, the computer could be a touchscreen and/or non-touchscreen and adopted to run on any type of OS, such as iOS™, Windows™, Android™, Unix™, Linux™, and/or others. In one embodiment, the plurality of computers is in communication with each other, via networks. Such communication is established via any one of application software, a mobile application, a browser, an OS, and/or any combination thereof.

In one embodiment, the one or more databases 110 are in communication with the computing device 108 via the network 104. In one embodiment, the databases 110 are accessible by the computing device 108. In another embodiment, the databases 110 are integrated into the computing device 108 or separate from it. In some embodiments, the databases 110 reside in a connected server or a cloud computing service. Regardless of location, the databases 110 comprise a memory to store and organize certain data for use by the computing device 108. In one embodiment, the database 110 is configured to store a plurality of candidates information.

In one embodiment, the computing device 108 comprises at least one processor and a non-transitory memory unit or computer-readable medium or memory unit coupled to the processor. The memory unit stores a set of instructions executable by the processor configured to find candidate profiles who match based on assigned task and candidate expertise. In one embodiment, the matching of candidates is done using artificial intelligence (AI) guided adaptive talent matching. The memory unit could be RAM, ROM (including EPROM, EEPROM, PROM).

In one embodiment, the computing device 108 is configured to enable candidates to sign-up with a Web2 identity or Web3 identity; enable candidates to self-attest to skills and personal profiles; assign task or gig by executive recruiters or corporate users; match executive recruiters or corporate users and candidates based on task profile and candidates expertise; provide dynamic rating for candidates and small and medium size enterprises (SMEs).

In one embodiment, the system 100 utilizes a unique four-pillar talent accreditation process that allows community champions to review and authenticate the talent on or platform across one or more criteria. The one or more criteria include industry and domain skill/knowledge, technical skills, soft skills or leadership skills, and domain expert validation or local community endorsements. The industry and domain knowledge includes industry specific expertise and domain subject matter expertise. The technical skills include tech skills, legal technology expertise, and emerging technology experience. The soft or leadership skills include leadership soft skills, DISC profile, Gallup Clifton strengths, predictive index, agile/lean thinking, and business strategy. The local community endorsement includes domain expert validation vetting and actual on the ground candidate working experience.

In one embodiment, the system rates the proven talent based on a proprietary rating engine. In one embodiment, the system stores a plurality of candidate details or traits on a combination of an encrypted database and the blockchain. The private details are personal identifiers such as first name, last name, and email are stored exclusively in encrypted format on a database. Candidate traits like such as skill credentials are attested to by storing trust material on the blockchain. Further, only candidate personas are stored. In one embodiment, the full record is accessible with only a private key. The system eliminates others to access the record with private data except the candidate.

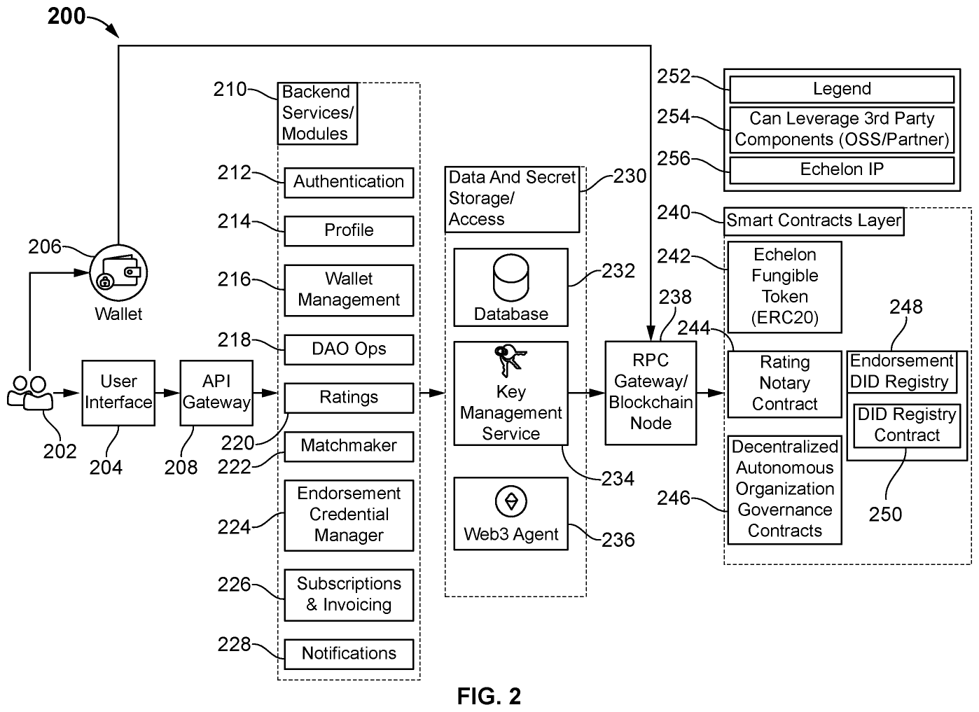

Referring to FIG. 2, a high-level architecture 200 of the system is illustrated. In one embodiment, the system architecture 200 comprises a user device with a user interface 204 associate with a user 202. The user device is at least any one of a smartphone, a mobile phone, a tablet, a laptop, a desktop, or other suitable hand-held electronic communication devices. The user 202 has a digital wallet or wallet 206 configured to store one or more user's skill credentials. The digital wallet 206 is associated with a Remote Procedure Call (RPC) gateway or blockchain node 238.

In one embodiment, the user interface 204 communicates with one or more modules via an application programming interface (API) gateway 208. In one embodiment, the one or more modules are backend service modules 210. The backend service modules 210 comprise an authentication module 212 configured to take care of all authentication flows of both web2 and web3 interactions. The authentication module 212 provides an API to enable role-based access control to all calls that pass through the API gateway. In one embodiment, the backend service modules 210 further comprise a profile module 214. The profile module 214 is configured to manage profiles of all entities on the system including the ability to unlock the profiles during the matching process.

In one embodiment, the backend service modules 210 further comprise a wallet management module 216. The wallet management module 216 is configured to provide a cloud wallet implementation that leverages the data store and the key management service to facilitate web3 interactions for user who do not want to manage their own wallet. In one embodiment, the backend service module 210 further comprises a decentralized autonomous organization (DAO-Ops) module 218. The DAO-Ops module 218 is configured to augment the state stored on a ledger for managing votes, members, and other pieces of the DAO Governance.

In one embodiment, backend service module 210 further comprises a rating module 220. The rating module 220 is configured to cache and effectively update ratings associated with profiles in real time. The rating module 120 facilitates four-pillar dynamic rating calculations. In one embodiment, the backend service module 210 further comprises a matchmaker module 222. The matchmaker or matching module 222 is an artificial intelligence (AI) or machine learning (ML) powered matchmaking engine configured to determine candidates with the best-fit to prospective gig opportunities. The matching model 222 is trained based on multiple dimensions of information available in the system, and it incrementally learn from the outcomes i.e., successes or failures, of previous assignments.

In one embodiment, the backend service modules 210 further comprise an endorsement module 224. The endorsement module 224 is configured to handle all flows that pertain to SMEs/Validators endorsing/vouching for candidates on the platform. This can include issuance, revocation and verification of skill credentials, used in the process of endorsement. In one embodiment, the backend service modules 210 further comprise a subscription and invoicing module 226 configured to provide subscription and invoice information to the users. In one embodiment, the backend service modules 210 further comprise a notification module 228 configured to provide notifications to the users 202.

In one embodiment, the backend service modules 210 communicate with a data and secret storage module 230. The data and secret storage module 230 is configured to access stored data and sources of truth. The data and secret storage module 230 comprises a database 232. The database 232 is a standard SQL/NoSQL store for maintaining app state. In one embodiment, the data and secret storage module 230 further comprises a key management service 234. The key management service 234 is used for secret management. The key management service 234 includes cloud wallet private keys and system keys for interacting with smart contracts. The data and secret storage module 230 further comprises a Web3 Agent 236. The Web3 Agent 236 is configured to handle all web3 interactions for the backend services, including managing identities and interfacing to the RPC API.

In one embodiment, the data and secret storage module 230 communicates with the RPC Gateway or blockchain node 238. The RPC Gateway 238 acts as the interface between the blockchain network and the backend service modules 210 or the wallet (user's agent) of choice. For example, an open RPC gateway is infura (on Ethereum).

In one embodiment, the RPC Gateway 238 then communicates with a smart contracts layer 240. The smart contracts layer 240 comprises an echelon Token 242. The token 242 is a fungible, possibly ERC20/ERC777 token configured to maintain primary fungible token. The ERC20 is a standard non-fungible token that makes each token exactly be the same as another token. In one embodiment, the smart contracts layer 240 further comprises a ratings notary module 244. The ratings notary module 244 is configured to perform notarizes ratings on-chain, thereby enabling an immutable historical record of all rating occurrences across the system. In one embodiment, the smart contracts layer 240 further comprises one or more decentralized autonomous organization (DAO) governance contracts 246. The DAO governance contracts have a set of governance contracts to manage a DAO. Further, the DAO governance contracts depend on the chosen DAO platform which in turn depends on the chosen ledger implementation.

In one embodiment, the smart contracts layer 240 further comprises an endorsement decentralized identity (DID) registry The endorsement DID registry 248 comprises a DID registry contract 250. The endorsement for skills is done using DID. Optionally, the registry 248 tracks issuances and revocations on-chain. Depending on the DID method utilized, issuances may or may not be maintained on chain. In one embodiment, the system architecture 200 further comprises a legend module 252. The legend module 252 leverages third party components 254 and echelon IP 256. The third-party components 254 may include, but not limited to, OSS or partners.

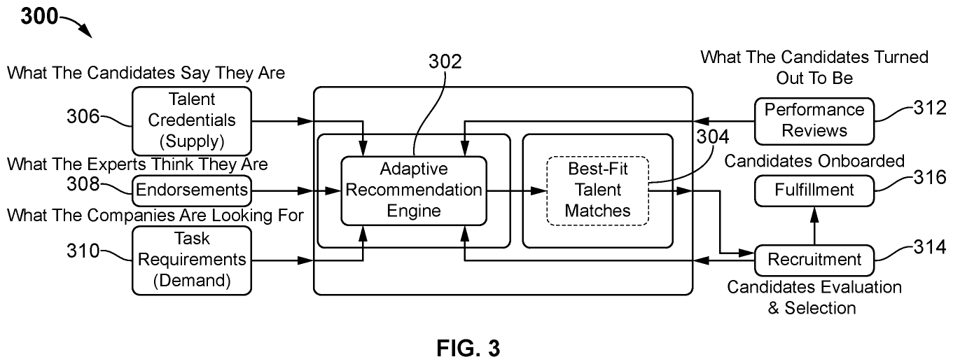

Referring to FIG. 3, an AI-guided adaptive talent matching 300 is illustrated. In one embodiment, the AI-guided adaptive talent matching 300 comprises an adaptive recommendation engine 302 and a best-fit talent matches 304. The adaptive recommendation engine 302 processes information comprising talent credentials (supply—i.e., what the candidates say they are) 306, endorsements (i.e., what the experts think they are) 308, and task requirements (demand—i.e., what the companies are looking for) 310. The AI-guided adaptive talent matching 300 utilizes natural language processing (NLP) to process the information such as talent credentials 306, endorsements 308, and task requirements 310. In one embodiment, the AI-guided adaptive talent matching 300 generates a capability map using talent credentials 306 and endorsements 308. The capability map may include, but not limited to, achievements, experience, and skillset of candidates. In one embodiment, the AI-guided adaptive talent matching 300 generates a requirement map using task requirements 310.

In one embodiment, the adaptive recommendation engine 302 further processes information such as performance reviews (i.e., what the candidates turned out to be) 312 and recruitment (i.e., candidates evaluation and selection) 314. The adaptive recommendation engine 302 process all the information to recruit candidates fulfillment (i.e., candidates onboard) 316 using best-fit talent matches 304. In one embodiment, the AI-guided adaptive talent matching 300 provides feedback including merits and demerits (i.e., what the candidates ended up to be).

The AI-guided adaptive talent matching 300 further provides talent matching and scoring using an adaptive ML model. The adaptive ML model may include multi-dimensional long short-term memory (LSTM). In one embodiment, the talent matching is done by leveraging artificial intelligence, which saves ton of manual time and efforts, while improves accuracy and demand fit. The demands come with various requirement characteristics, some hard skills and some soft skills, some must-haves and nice-to-haves, some focusing on particular areas and others generalized enough for leadership positions. Similarly, talent comes with an assortment of credentials and skillsets graded in different levels along with their endorsements, achievements, and experience. Taking these multi-dimensional attributes and weighting them appropriately and evaluating them against the demand characteristics require an effective and adaptive algorithm to provide best-fit matches which are vetted, ranked and ready for evaluation and fulfillment.

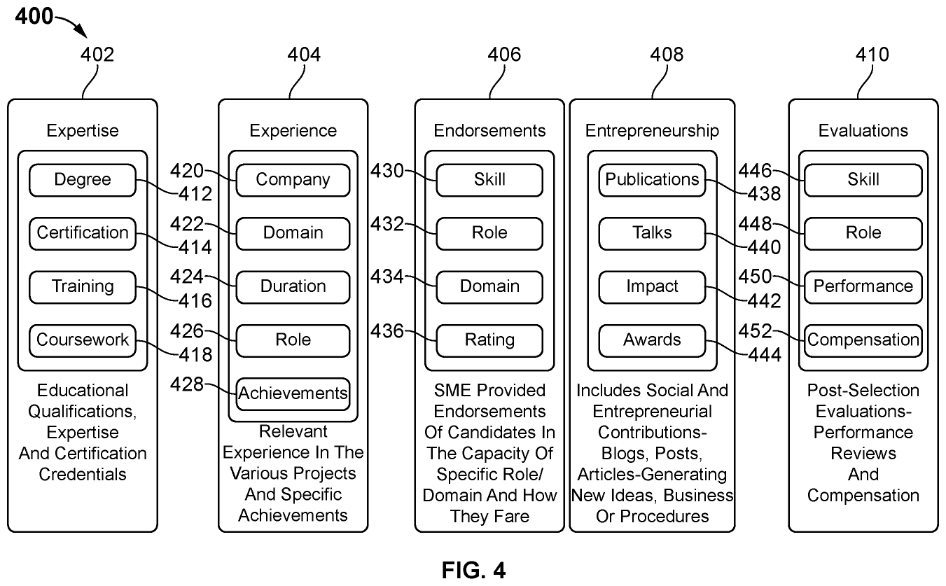

Referring to FIG. 4, an estimated talent worth algorithm 400 is illustrated. The estimated talent worth algorithm 400 is executed based on expertise 402, experience 404, endorsements 406, entrepreneurship 408, and evaluations 410. The expertise 402 is educational qualifications, expertise, and certification credentials. The expertise 402 includes degree 412, certification 414, training 416, and coursework 418. The experience 404 is relevant experience in the various projects and specific achievements. The experience 404 includes company 420, domain 422, duration 424, role 226, and achievements 228. The endorsements 406 is endorsements of candidates in the capacity of specific roles or domain and how they fare provided by the SMEs. The endorsements 406 include skill 430, role 432, domain 434, and rating 436. The entrepreneurship 408 includes social and entrepreneurial contributions such as blogs, posts, articles, generating new ideas, business or procedures. The entrepreneurship 408 further includes publications 438, talks 440, impact 442, and awards 444. The evaluations 410 are post-selective evaluation comprising performance reviews and compensation. The evaluations 410 include skill 446, role 448, performance 450, and compensation 452.

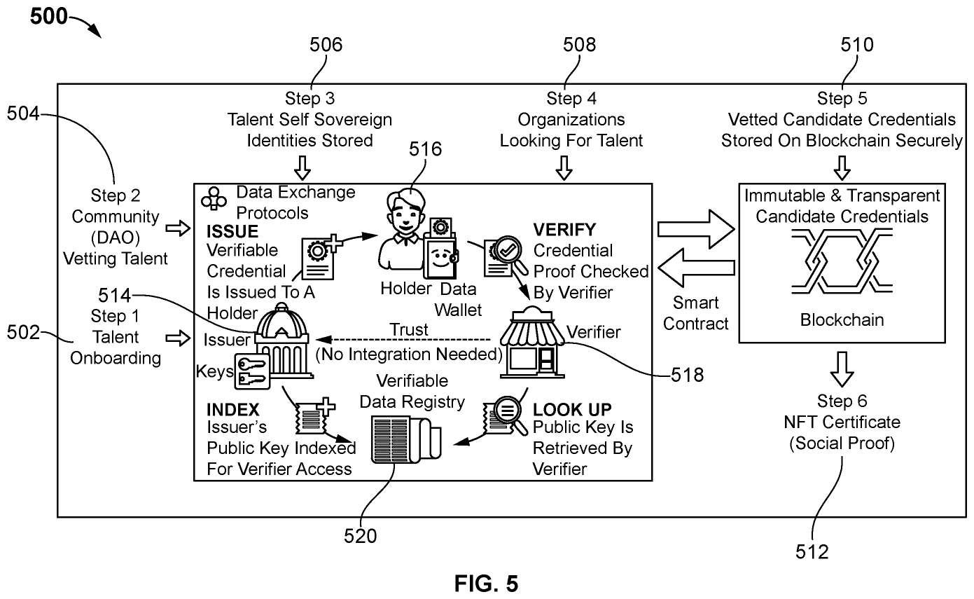

Referring to FIG. 5, self-sovereign identities (SSI) and blockchain decentralization 500 is illustrated. The trust over IP is a platform that uses a decentralized blockchain framework and community vetting to identify talent matches for organizations or clients. In one embodiment, the platform comprising talent is connected to recruiters using the AI matchmaking system that leverages dynamic rating and SSI (Self Sovereign ID) skill credentials. In one embodiment, SSI is an approach to digital identity for the user. The SSI is Web3 integration with trust over IP framework.

In one embodiment, the SSI identities are obtained by the users in a blockchain network using following steps. At step 502, the talent onboarding candidate submits profiles. At step 504, the system performs community vetting or referring of talent based on past project experience. At step 506, the talent credentials or self-sovereign identities are stored on an echelon platform securely. At step 508, the organizations look for talents or best-fit for the job. The organization includes a recruiter, headhunter, and a small business talent acquisition. At step 510, vetted candidates credentials stored on blockchain securely using a private key via a smart contract. At step 512, the stored credentials are provided with non-fungible token (NFT) certificate.

The SSI identities and blockchain decentralization 500 includes an issuer 514, holder 516, a verifier 518, and a verifiable data registry 520. The issuer 514 issues verifiable credentials to the holder 516. The holder 516 includes a data wallet for storing the received credentials. The stored credential is proof checked by a verifier 518, the issuer 514 includes a public key indexed for verifier access. Further, the verifier 518 retrieves a public key for verifying in a verifiable data registry 520. The verified credentials are stored in the blockchain (for instance, Ethereum) via a smart contract. The credentials are immutable and transparent candidate credentials.

In one embodiment, each skill credential cryptographically affirms the following three attributes, which include: the issuer of the skill credential is identified by their decentralized identity (DID); the type of skill being endorsed (represented as a skill tag for instance, “database-design”); and the recipient of the skill credential are also identified by their DID. There may be more than one skill as part of one skill credential, and they are represented as “claims” in the credential. The skill credential is represented as a verifiable credential (VC), conforming to the W3C VC data model. The VC credentials are tamper-proof credentials that are verified cryptographically.

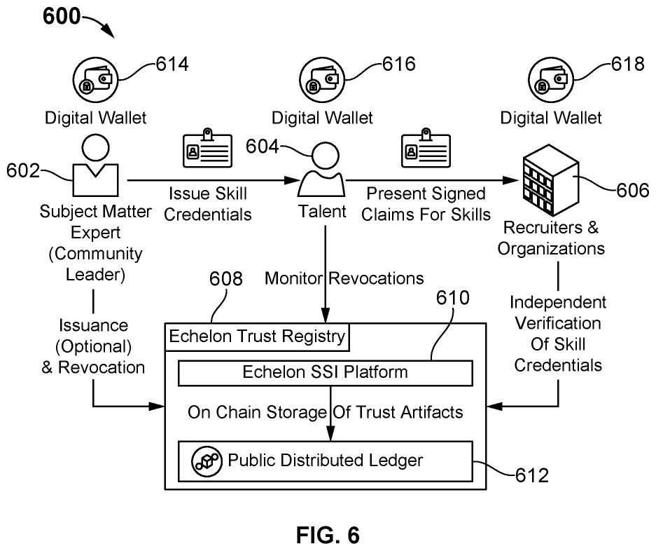

Referring to FIG. 6, a system 600 for SSI credential based talent and technology vetting with DAO capabilities is illustrated. The system 600 comprises a subject matter expert (i.e. community leader) 602 having a digital wallet 614. The subject matter expert 602 issues skill credentials by leveraging a trust registry or echelon trust registry 608. The trust registry is the entity used to verify, issue, and revoke the credentials. These credentials are stored in an SSI digital wallet. As these stakeholders may or may not care about controlling their own data, the echelon substrate (i.e., a set of helper services and capabilities) enables them to delegate ownership and management of this wallet to echelon. The trust registry 608 includes an echelon SSI platform 610 and a public distributed ledger 612 for on-chain storage of trust-artifacts.

In one embodiment, the system 600 comprises one or more entities leveraging the trust framework. The subject matter expert or issuers 602 use the echelon trust registry 608 to issue a skill credential which is sent over to the talent/candidate 604 in the form of a verifiable credential (VC). This issuance is referred to as an “endorsement”. The talent or candidate 604 possesses a digital wallet 614, in which one or more of these skill credentials are stored. Further, the talent or candidate 604 monitors revocation with the echelon trust registry 608. In one embodiment, when the talent or candidate 604 wants to reveal and prove their skill credential to a recruiter or organization 606, they are able to do so by creating a proof presentation cryptographically from the claims in the set of verifiable credentials stored in their wallet 618. The recruiter or organization 606 performs independent verification of skill credentials with the echelon trust registry 608.

As for the SMEs and community leaders, they are vetted by a decentralized autonomous organization (DAO) that votes on the eligibility of a given SME against one or more skills by use of a multisig (multiple signatures) proposal. If this multisig vote is concluded to be affirmative, a credential is issued to the SMEs by the echelon trust anchor. Each entity is also rated on the platform, with the ratings being notarized on the decentralized ledger. The rating actions include rating the hired talent or candidate on their work by the recruiter or organization and rating the recruiter by the talent or candidate.

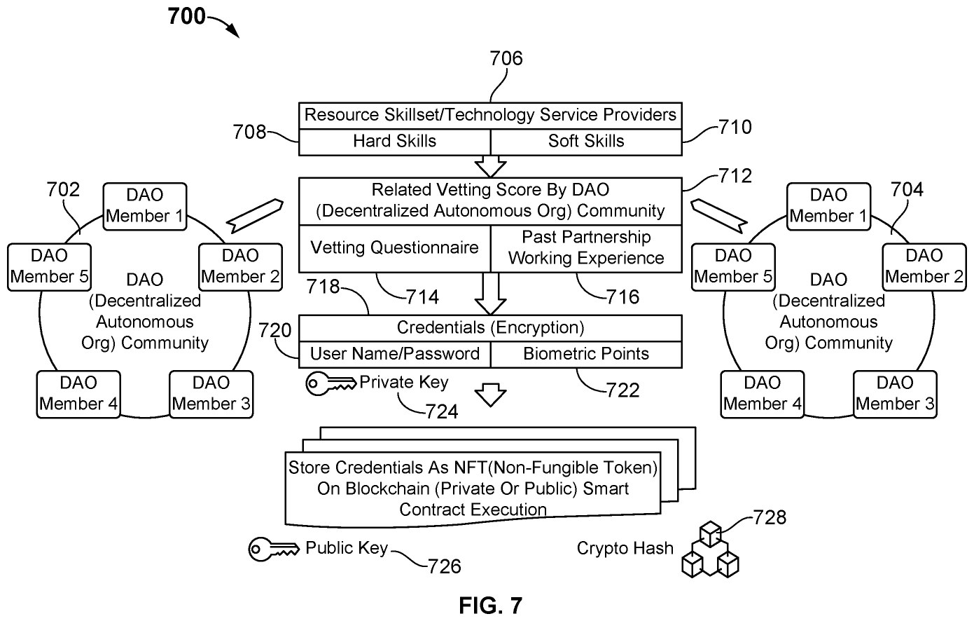

Referring to FIG. 7, a talent and technology service provider system 700 onboarding via DAO community is illustrated. The system 700 is a DAO vetted self-sovereign verifiable credentialed & Non-Fungible Token (NFT) based talent and technology service provider platform. The system 700 comprises one or more decentralized autonomous organization (DAO) community (702 and 704) comprising one or more DAO members. The talent onboarding is performed using resource skillsets or technology service provider's 706 comprising hard skills 708 and soft skills 710. The resource skills 706 are vetted by the DAO community. Each resource skills 706 are vetted by related vetting scores 712 based on vetting questionnaires 714 and past partnership working experience 716. The vetting scores 712 are provided with credentials (i.e., encryption) 718. The encryption of the credentials 718 is done using username and password 720 and other optional multi factor authentication schemes 722. In one embodiment, the system 700 stores credential proof material on the blockchain with cryptographic signatures with optional NFT minting. Further, the skill credentials minted into NFTs are anchored to the blockchain network.

In one embodiment, the tech service providers recruit talents or a sample talent onboarding on the platform. The recruitment of talents onboarding by the tech service providers is made by following process. At one step, tech talent or candidates are referred by well-respected community or direct to echelon onboarding Link. At another step, the candidate submits all the credentials via a user device using mobile application or web-based application or desktop application. At another step, the credible group of community members with the candidate experience validates all the credentials. At another step, the candidate credentials are stored on emerging blockchain technology for transparency and immutability. At another step, the organization looking for tech talent finds candidates based on their reputation using AI profile matching. At another step, the candidate and organization maturity and culture match are performed using worth and reputation algorithm and the offers are rolled out to the candidates. At another step, the candidate, community, and organization get the echelon scores and respective tokens based on the recurring feedback and reputation is scored quantitatively.

In one embodiment, the system 700 provides consolidated list of credible/vetted talent and allows the users to access blockchain using the following steps. At one step, the recruiter/organization put up a “task” which contains metadata such as description and required skill sets. The required skill sets are represented as skill tags. At another step, the AI matchmaker utilizes the skill tags and dynamic rating to notify one or more eligible talent/candidates. At another step, the system allows the talent/candidates to “apply” for the opportunity by providing consent, which allows the system to create a proof presentation of the “skill tag” claims requested by the organization. At another step, the organization now sees a list of candidates, with just their descriptions and skill tags. Further, the organization chooses to “unlock” one or more candidates, which allows them to contact and proceed with the process.

Further, a verifying party does not have to trust Echelon directly to verify a skill tag as they can directly access the distributed ledger and verify the cryptographic proof presentation to know that a specific SME has issued the endorsement. In this way, the skill endorsements are universally verifiable, as long as the verifier establishes a link between the SMEs real-world identity and their DID.

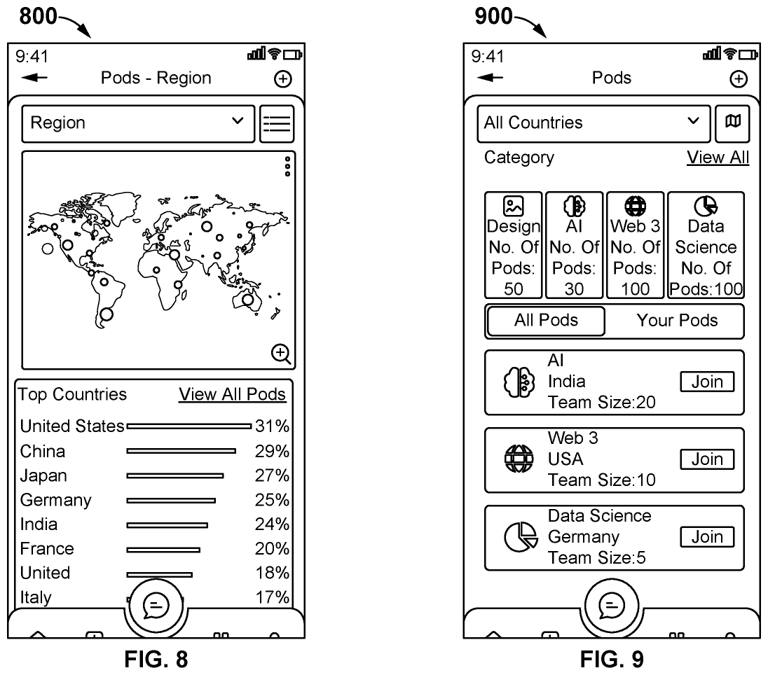

Referring to FIGS. 8-9, screenshots (800 and 900) illustrating a list of teams with diverse capabilities to achieve the needs of the client DAO (PODs) are disclosed. The teams work in collaboration to achieve the needs of the client DAO. The PODs from different regions of different countries are exemplarily illustrated in FIG. 8. The screenshot 800 allows the user to select the particular region using a drop-down option. Further, the screenshot 800 lists the countries with maximum PODs (in percentage). The PODs of different categories are exemplarily illustrated in FIG. 9. The screenshot 900 shows the PODs classified under different categories such as design, AI, web 3, and data of science. The screenshot 900 allows the user to join on any category of POD.

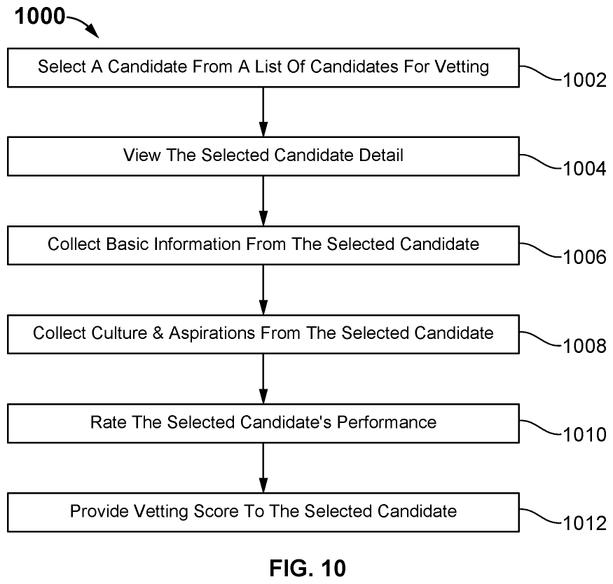

Referring to FIG. 10, a flowchart 1000 of pre-vetted candidates & PODs, and DAO community vetting is disclosed. The dedicated application software performs the following steps configured to provide pre-vetted candidates & PODs, and DAO community vetting. Candidates are pre-vetted by the credible Echelon community, wherein the vetting is incentivized by rewards, for example, tokenomics. At step 1002, the application software allows the recruiter/organization to select a candidate from a list of candidates registered in it. The recruiter may select any candidate for vetting. At step 1004, the application software allows the recruiter to view the details of the selected candidate. At step 1006, a plurality of basic information is collected from the candidate. The basic information may include, but are not limited to, name of the candidate, industry experience, domain experience, project details, etc. At step 1008, the application software further collects culture and aspirations from the selected candidate. At step 1010, the application software then allows the recruiter to evaluate and rate the performance of the selected candidate. At step 1012, the recruiter provides vetting score to the selected candidate based on the evaluation. Further, the application software average vetting score of the selected candidate by calculating the vetting scores provided by different recruiters.

In one embodiment, the dedicated application software further notifies the candidate regarding their reputation score. Also, the application software shows a graphical representation of the reputation score over time and profile vetting. Further, the candidate profile shows the candidate details such as candidate name, achievements such as reputation score, rank, etc.

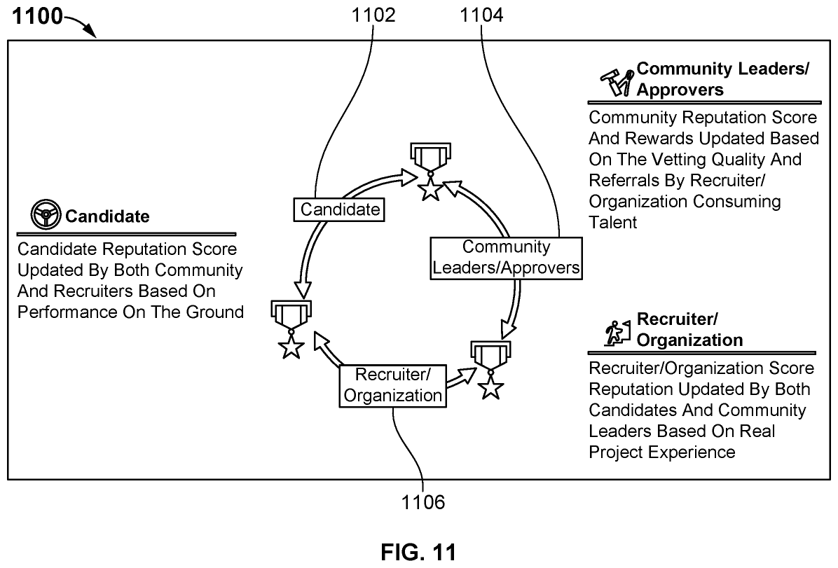

Referring to FIG. 11, a schematic diagram 1100 that describes the tokenomics—qualitative & quantitative accountability at all layers and Echelon Token of the DAO. The diagram 1100 shows the relationship between different layers such as candidate 1102, community leader/approver 1104, and recruiter/organization 1106. Each layer (1102, 1104, and 1106) is updated with a score based on their performance. The candidate layer 1102 includes candidate reputation score. The candidate reputation score is updated by both community and recruiters based on performance on the ground. The community layer 1104 includes community reputation score. The community reputation score and rewards are updated based on the vetting quality and referrals by recruiter/organization consuming talent. The recruiter layer 1106 includes recruiter/organization reputation score. The recruiter/organization reputation score is updated by both candidates and community leaders based on real project experience.

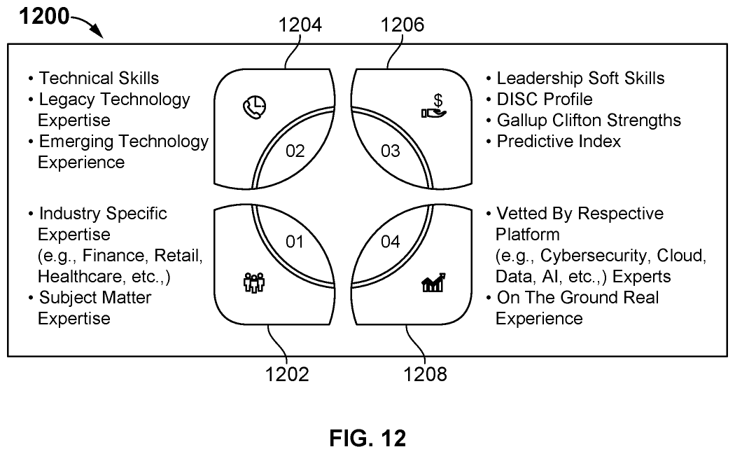

Referring to FIG. 12, 4-pillar accreditation 1200 is disclosed. The 4-pillar 1200 includes industry 1202, technology 1204, soft skills 1206, and domain expert validation 1208. The industry 1202 includes industry specific expertise and subject matter expertise. The industry specific expertise may include finance, retail, healthcare, etc. The technology 1204 includes technical skills, legacy technology expertise, and emerging technology experience. The soft skills 1206 include leadership softskills, DISC profile, Gallup Clifton strengths, and predictive index. The domain expert validation 1208 includes vetted by respective platform, for example, cybersecurity experts, cloud data experts, AI experts, etc., and on the ground real experience.

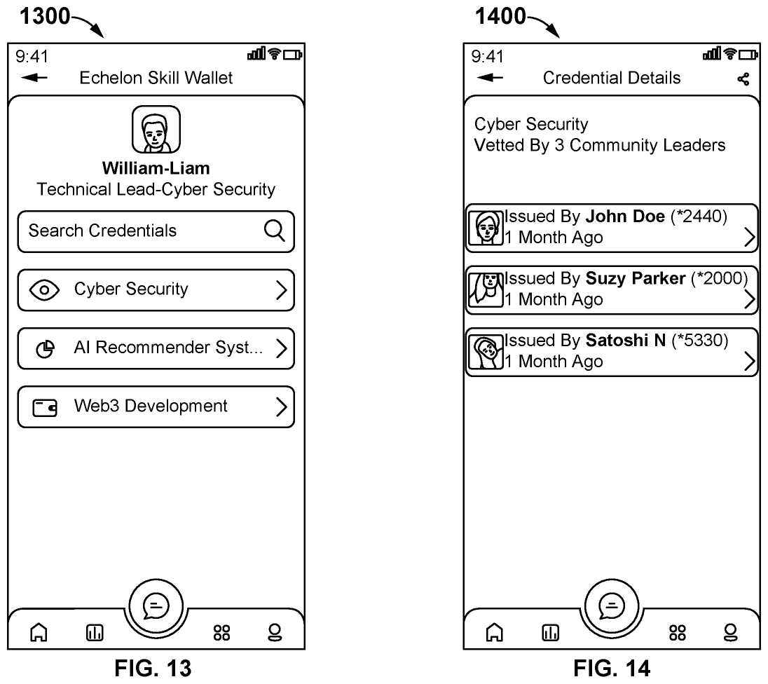

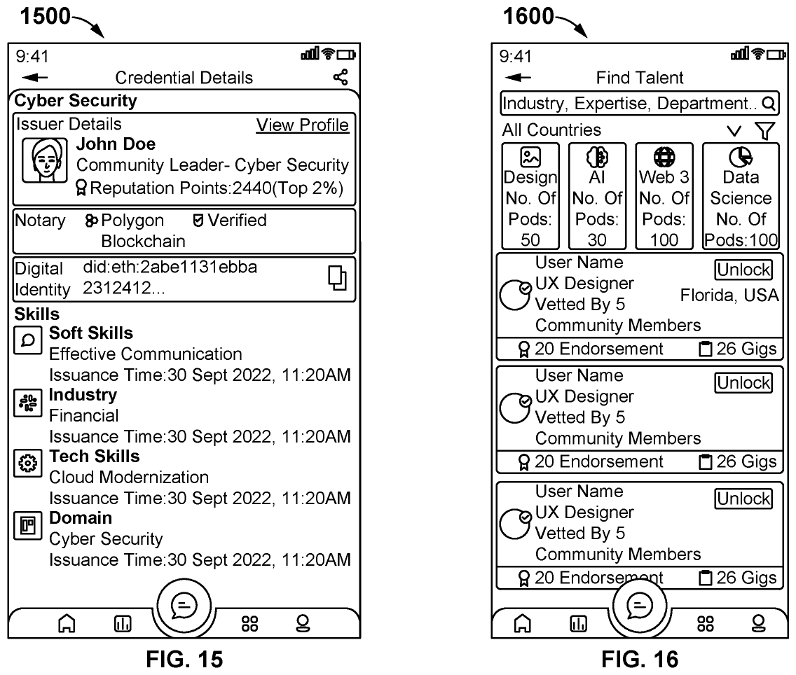

Referring to FIGS. 13-15, screenshots (1300, 1400, and 1500) illustrating a digital skills wallet of a candidate are disclosed. The screenshot 1300 shows the skill wallet of a selected candidate. Each candidate has a digital skills wallet having multiple skills vetted/approved by community leaders with the 4-pillar accreditation. The skill wallet comprises one or more credentials, for example, cyber security, AI recommender system, and Web3 development (as shown in FIG. 13). The candidate may select any of the credentials. The screenshot 1400 shows the credential details by clicking on a particular skill. For example, the screenshot 1400 shows the credential details of cyber security skill. By selecting a particular skill, the application software allows the candidate to view the leaders/recruiters/organizations who approve the skills in the wallet (as shown in FIG. 14). The screenshot 1500 shows the details of the leader/recruiter/organization. The application software allows the candidate to select any of the vetted leader/recruiter/organization to view their details (as shown in FIG. 15).

Referring to FIG. 16, a screenshot 1600 illustrating candidate privacy is disclosed. The screenshot 1600 shows a list of users and a plurality of candidate details such as talent, user name, designation, number of vetted community leaders, etc. The candidate has a full control on their data. The candidate privacy may not be available to recruiters. The recruiters can only view the candidate profile when candidate shares access to their data. It improves candidate privacy as well as allow the recruiters to select any candidate to view and approve their skill in vetting process.

According to the present invention, the system 100 mitigates contractual commitment and other risks (i.e., reduce procurement friction), and the platform takes care of payments and contractual risk. Also, the system 100 includes niche vendors specialized in regulatory bodies/frameworks e.g., Cloud Security Alliance Cloud Controls Matrix, and NIST. In addition, the system 100 updates weekly and monthly new talent availability and tech service capabilities. Further, the system allows the talent and tech providers to log their credentials on blockchain, where the credentials are immutable digital certified. As the verifiable credentials and NFTs facilitated the blockchain are immutable, it clearly eliminates copyright issues, and no more body shopping without due diligence. The tech vendor due diligence methodology includes key foundational architectural principles such as domain driven design (DDD), value stream mapping, and micro services.

The system of the present invention performs accelerated mentoring or career advice accelerator program, personalized advice by proven community leaders, and helps in identifying true leaders. Further, the system achieves on time hiring. The system also provides omnichannel experience, both on the web and mobile with following key capabilities:

The system provides tracking of “real-time” worth. The users of the present system will have a score—based on their actual capabilities and reputation. Further, the system will have vetted score that is current and captures a more holistic picture of the individuals' worth and can be shared as they wish.

The system further provides guaranteed, qualified, vetted, and quality tech talent. The system performs community vetting of all talents registered on the platform. This ensures relevance, quality and integrity and clients looking for candidates have the guarantee of great candidates and teams for their jobs and projects. Further, the system accelerates candidates career confidently and confidentially.

The system further provides transparency and optimizes the entire process. With a decentralized Blockchain or Web3 architecture and DAO principles, the system enables more transparency while also giving the power of individuals to manage their reputation to themselves with validated authenticity through community vetting. Also, the system enables easy and convenient access to the platform and its functions through any device such as web and mobile making it very convenient and optimal to manage in real-time.

The system further provides an ability to create and register PODs-Global Ranking. The system provides the capability to find an entire team i.e., a SEAL team or POD to take on projects as required. Teams that work together and have achieved success can also register as a unit and get vetted and assigned a score or ranking for specific skills and technologies. This will make it easier for clients to staff for larger projects with teams rather than hiring one person at a time.

The system incorporates Web3, DAO, and AI/ML emerging technologies. The system of the present invention powers the platform with one or more architectural frameworks and principles as well as AI/ML to help talent to find their jobs effectively and for companies and organizations to find the talent they need quickly and reliably.

The system is powered by a credible community vetting process. The present system comprises a community of respected industry experts to vet registered candidates based on their experience and give credibility to any job applicants, so the clients can hire with confidence. The community of experts/advisors will be compensated with Echelon tokens and/or regular currency as appropriate.

Advantageously, the system of the present invention tracks candidate's real-time worth like a stock with private digital identity. Also, the system is vetted by DAO community of industry domain experts. Further, the system is reliable, cultural-fit, and ready for gig-economy. The system further uses modern technology (i.e., Web3) that provides greater efficiency and security. The system is more versatile in available functions including the ability to hire teams, create contracts. Moreover, the system includes greater transparency in the process and no fake resumes are processed.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A computer-implemented system for real-time credible vetting of talents using blockchain, comprising:
a computing device having at least one processor and a computer-readable medium coupled to the processor, wherein the computer-readable medium stores a set of instructions executable by the processor configured to perform real-time credible vetting of talents or candidates using blockchain, wherein the system is in communication with the computing device through a communication network;
one or more databases in communication with the computing device via the communication network configured to store a plurality of candidate information, and
a user device associated with each user in communication with the computing device via the communication network configured to access one or more services provided by the system, wherein the computing device is configured to;
allow candidates to submit one or more candidate credentials into the system;
validate candidate credentials by a credible group of community experts;
store candidate credentials on the blockchain for access by the recruiters or organizations after consent from the candidate;
assign task by organizations to the candidates;
match organizations and candidates based on task profile and candidate's expertise, and
provide dynamic ratings and scores for candidates along with feedback.

2. The system of claim 1, is a decentralized autonomous organization (DAO decentralization) vetted self-sovereign verifiable credentialed & Non-Fungible Token (NFT) based talent and technology service providers platform to find reliable candidates.

3. The system of claim 1, wherein the user device is configured to communicate with the computing device via the communication network using an application software or mobile application or web-based application, or desktop application executed in a computer-implemented environment or network environment.

4. The system of claim 1, utilizes one or more next generation internet technologies including decentralization, blockchain technologies, and token-based economies configured to identify candidates with greater credibility.

5. The system of claim 1, wherein the community experts are a team of experts from a part of recruitment community of an organization.

6. The system of claim 1, is built-on emerging on self-sovereign identity (SSI), AWS cloud and Web3, blockchain, decentralization, and artificial intelligence configured to perform profile matching of organizations and candidates.

7. The system of claim 1, wherein the profile matching is performed using an artificial intelligence (AI) guided adaptive talent matching.

8. The system of claim 1, wherein the dynamic rating or score is provided to the candidates based on specific skills and technology.

9. The system of claim 1, further includes a unique four-pillar talent accreditation process configured to allow the community experts to review and authenticate the candidate on one or more criteria.

10. The system of claim 9, wherein one or more criteria includes domain knowledge, technical skills, soft or leadership skills, and local community endorsements.

11. The system of claim 1, further comprises a digital wallet associated with an RPC gateway or blockchain node configured to store one or more candidate skill credentials.

12. The system of claim 1, further comprises a profile module configured to manage profiles of all entities on the system including the ability to unlock profiles during the matching process.

13. The system of claim 1, wherein the vetting of candidates' skills is performed based on technical skills and soft skills.

14. The system of claim 13, wherein the soft skills include communication, leadership, teamwork, overall attitude, and ability to adapt.

15. The system of claim 1, wherein the vetting of skills is performed relating to vetting scores based on vetting questionnaires and past partnership working experience.

16. The system of claim 1, wherein the vetting scores are provided with encryption of the credentials using username and password and other optional multi factor authentication schemes.

17. The system of claim 1, wherein the credentials are stored as self-sovereign verifiable credentials, utilizing the blockchain as a trust registry

18. The system of claim 1, wherein the self-sovereign verifiable credentials are minted into NFTs (Non-Fungible Tokens)
